(19) United States
(12) Patent Application Publication
(10) Pub. No.: US 2025/0010860 A1
(43) Pub. Date: Jan. 9, 2025

(54) METHOD AND DEVICE FOR CONTROLLING AN AUTOMATICALLY DRIVING VEHICLE

(71) Applicant: MERCEDES-BENZ GROUP AG, Stuttgart (DE)

(72) Inventors: Markus GRESSMANN, Stuttgart (DE); Christoph KELLER, Stuttgart (DE); Holger MIELENZ, Ostfildern (DE)

(21) Appl. No.: 18/712,330

(22) PCT Filed: Nov. 1, 2022
(86) PCT No.: PCT/EP2022/080439

§ 371 Date: May 22, 2024

(30) Foreign Application Priority Data
Nov. 23, 2021 (DE) 10 2021 213 166.2

(51) Int. Cl. B60W 30/18; B60W 50/00; B60W 60/00; B62D 6/00

(52) U.S. Cl. CPC B60W 30/18154; B60W 50/0097; B60W 60/001; B62D 6/00

(57) ABSTRACT

A method for controlling an automatically driving vehicle in the region of a crossroads using data recorded by a surroundings recording sensor system is provided. Before reaching the crossroads along a roadway lying ahead of the vehicle until the crossroads are reached, several future vehicle positions are determined as stopping point candidates. For each of the stopping point candidates, a field of vision of the surroundings recording sensor system is predicted considering an elevation profile of a carriageway surface in the region of the crossroads. The stopping point candidate at which the surroundings recording sensor system has the greatest field of vision is selected as the stopping position of the vehicle. At the stopping position, the vehicle surroundings are recorded by the surroundings recording sensor system. Depending on a traffic situation ascertained from the data of the surroundings recording sensor system, the vehicle is automatically steered into the crossroads.

### BACKGROUND AND SUMMARY OF THE INVENTION

Exemplary embodiments of the invention relate to a method for controlling an automatically driving vehicle, as well as to a device for controlling an automatically driving vehicle.

DE 10 2019 105 739 A1 discloses a method for partially automatically guiding a motor vehicle by visually concealing a surroundings sensor system of the motor vehicle with the following steps:
generating and emitting touch control signals for controlling a transverse and longitudinal guiding of the motor vehicle in order to partially automatically guide the motor vehicle in such a way that the motor vehicle feels its way into a road junction point;
receiving surroundings signals which represent the surroundings of the motor vehicle while feeling its way into the road junction point;
determining, based on the surroundings signals, that the motor vehicle may feel its way further into the road junction point, or have to stop or reverse,
generating and emitting control signals for controlling the transverse and longitudinal guiding of the motor vehicle based on the determination in order to partially automatically guide the motor vehicle corresponding to the determination in such a way that the motor vehicle feels its way further into the road junction point, stops or reverses.

Exemplary embodiments of the invention are directed to a novel method for controlling an automatically driving vehicle and a novel device for controlling an automatically driving vehicle.

In a method for controlling an automatically, in particular highly automatically or autonomously, driving vehicle in the region of a crossroads, data recorded by means of a surroundings recording sensor system is used.

According to the invention, before reaching the crossroads along a roadway lying ahead of the vehicle until the crossroads are reached, several future vehicle positions are determined as stopping point candidates. For each of the stopping point candidates, a field of vision of the surroundings recording sensor system is predicted, taking into consideration an elevation profile of a roadway surface in the region of the crossroads, wherein the stopping point candidate at which the surroundings recording sensor system has the greatest field of vision is selected as the stopping position of the vehicle. At the stopping position, the vehicle surroundings are recorded by means of the surroundings recording sensor system and, depending on a traffic situation ascertained from the data of the surroundings recording sensor system, the vehicle is automatically steered into the crossroads.

Using the method, a surroundings recording can be significantly improved in the region of crossroads, which can be difficult for the surroundings recording sensor system of the vehicle to appreciate due to an elevation profile of the roadway surface, for example. Thus, a degree of safety for a vehicle when automatically driving across and passing through a crossroads is increased.

In a possible design of the method, an orientation of the vehicle at the stopping position is changed by means of an active chassis thereof in such a way that the field of vision of the surroundings recording sensor system is maximized. This makes a further improved surroundings recording in the region of crossroads possible.

In a further possible design of the method, a position of the vehicle at the stopping position is changed by an automatic longitudinal and/or transverse movement in such a way that the field of vision of the surroundings recording sensor system is maximized. In doing so, the surroundings recording in the region of crossroads can also be further improved.

In a further possible design of the method, the stopping point candidates are determined by means of map data of a digital road map. This constitutes a simple and reliable determination of the stopping point candidates.

In a further possible design of the method, the stopping point candidates are determined by means of model data of a surroundings model. This also constitutes a simple and reliable determination of the stopping point candidates.

In a further possible design of the method, the surroundings model is generated by means of the data of the surroundings recording sensor system. It advantageously emerges from this that the surroundings model is up to date, such that changes possibly present in the vehicle surroundings can be taken into consideration.

In a further possible design of the method, a three-dimensional further surroundings model of the vehicle surroundings is compiled using the data recorded at the stopping position by means of the surroundings recording sensor system of the vehicle surroundings, the surroundings model portraying the vehicle surroundings particularly reliably and accurately due to the large field of vision of the surroundings recording sensor system at the stopping position.

In a further possible design of the method, the orientation of the vehicle is ascertained for maximizing the field of vision of the surroundings recording sensor system by means of the three-dimensional further surroundings model and by means of map data of a digital road map. Thus, due to the particularly reliable and accurate portrayal of the vehicle surroundings, the enlargement of the field of vision can be particularly reliably maximized.

In a further possible design of the method, the steering of the vehicle into the crossroads is carried out by slowly feeling its way in. In doing so, the danger of a collision of the vehicle with other traffic participants can be reduced. The term “feeling its way in” is here to be interpreted according to the understanding of the person skilled in the art with regards to the German Road Traffic Regulations § 8. Here, it reads as follows in paragraph 2, clause 3: “If this cannot be viewed because the point in the road is unclear, you may carefully feel your way into the crossroads or junction until you have a clear view.”

A device for controlling an automatically driving vehicle in the region of a crossroads has a surroundings recording sensor system. According to the invention, the device has a processing unit, which is formed to determine several future vehicle positions as stopping point candidates before reaching the crossroads along a roadway lying ahead of the vehicle until the crossroads are reached. Furthermore, the processing unit is formed to predict a field of vision of the surroundings recording sensor system for each of the stopping point candidates, taking into consideration an elevation profile of a roadway surface in the region of the crossroads and to select the stopping point candidate at which the surroundings recording sensor system has the greatest field of vision as the stopping position of the vehicle. Furthermore, the device comprises a control unit, which is formed, depending on a traffic situation ascertained from data of the vehicle surroundings recorded at the stopping position by means of the surroundings recording sensor system, to automatically steer the vehicle into the crossroads depending on the traffic situation.

A surroundings recording in the region of crossroads, which can be difficult for the surroundings recording sensor system of the vehicle to appreciate due to an elevation profile of the roadway surface, for example, can be significantly improved by means of the device. Thus, a degree of safety for a vehicle when automatically driving across and passing through a crossroads is increased.

In a possible design of the device, this comprises an active chassis which is formed to change an orientation of the vehicle at the stopping position in such a way that the field of vision of the surroundings recording sensor system is maximized. This makes a further improved surroundings recording in the region of crossroads possible.

Exemplary embodiments of the invention are explained in more detail below by means of the drawings.

### BRIEF DESCRIPTION OF THE DRAWING FIGURES

Here are shown:

FIG. 1, schematically, a top view of a crossroads,

FIG. 2, schematically, a perspective view of several roadways,

FIG. 3, schematically, front views of a vehicle in different states, and

FIG. 4, schematically, a block wiring diagram of a device for controlling an automatically driving vehicle.

Parts corresponding to one another are provided with the same reference numerals in all figures.

### DETAILED DESCRIPTION

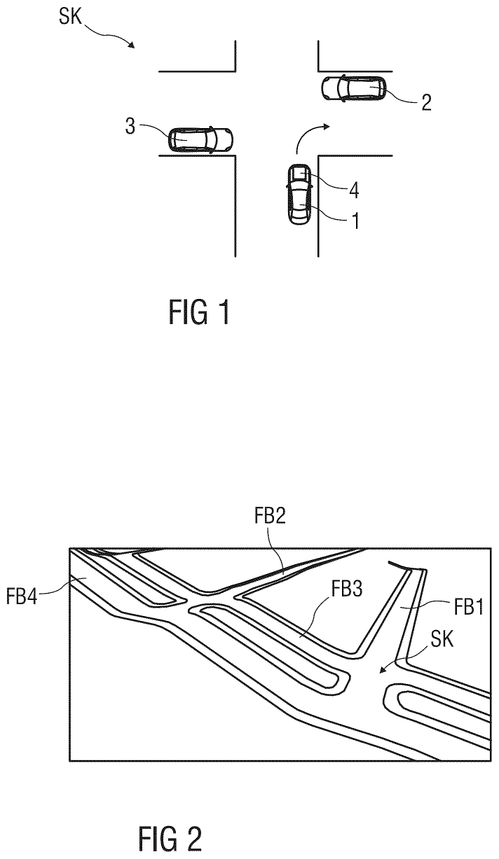

FIG. 1 illustrates a top view of a crossroads SK with a vehicle 1 and two further vehicles 2, 3.

The vehicle 1 is formed for an automatic, in particular highly automatic or autonomous, driving operation. To carry out the automatic driving operation, a recording of the vehicle surroundings is required. For this recording, the vehicle 1 comprises a surroundings recording sensor system 4.

Before the vehicle 1 drives across the crossroads SK, it is required that all other traffic participants, presently the further vehicles 2, 3, are recorded in order to safely drive across the crossroads SK while avoiding collisions and adhering to legal requirements, for example, right-of-way regulations.

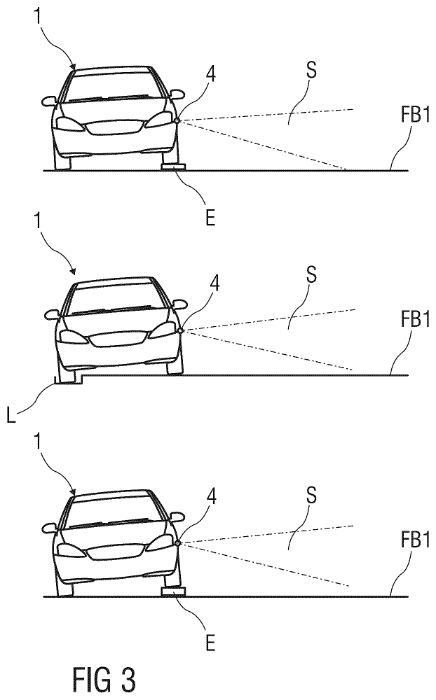

FIG. 2 shows a perspective view of several roadways FB1 to FB4, which are characterized at least partially by an undulating elevation profile of their roadway surfaces. In FIG. 3, front views of the vehicle 1 in different states on a roadway FB1 with an uneven roadway surface are depicted.

Due to the elevation profile of the roadways FB1 to FB4 and/or due to an uneven roadway surface, for example with potholes L and/or elevations E, with sensors of the surroundings recording sensor system 4 with limited vertical opening angles, it can result in limitations to a field of vision S. These limitations can lead to no sufficient recording of the roadway surface being possible and the corresponding sensor not being sufficiently suitable for recording the vehicle surroundings along a roadway FB1 to FB4 and for recognizing moving traffic participants.

In order to avoid such a limitation of the field of vision S, a device 5 and a method for controlling an automatically driving vehicle 1 are provided.

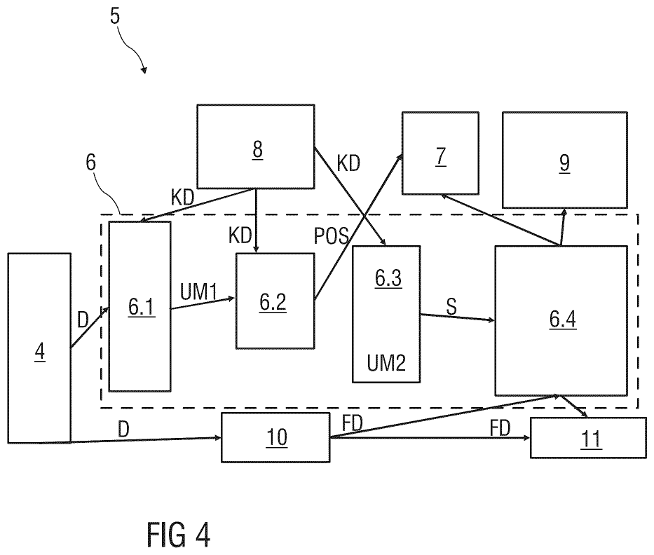

FIG. 4 shows block wiring diagram of a possible exemplary embodiment of such a device 5.

The device 5 comprises the surroundings recording sensor system 4, which comprises, for example, camera, radar and/or lidar sensors and/or further sensors for recording the vehicle surroundings. Furthermore, the device 5 comprises a processing unit 6 with several processing modules 6.1 to 6.4, a control unit 7, a digital road map 8, an active chassis 9 of the vehicle 1, fusion module 10 and a control module 11.

By means of the fusion module 10, data D recorded by means of several sensors of the surroundings recording sensor system 4 is fused to form fused data FD, wherein static and dynamic objects in the vehicle surroundings are recorded by means of the fused data FD.

A three-dimensional surroundings model UM1 is generated from data D recorded by means of the surroundings recording sensor system 4 and map data KD of the digital road map 8 by means of a first processing module 6.1 of the processing unit 6 by means of a prediction of a profile of the roadway surface and a roadway surface recording, for example potholes L and/or elevations E.

Subsequently, in a second processing module 6.2 of the processing unit 6, an ascertaining of a stopping position POS of the vehicle 1 from a multitude of stopping point candidates, which constitute future vehicle positions on a roadway lying ahead of the vehicle 1, is carried out by means of the surroundings model UM1 and the map data KD. Here, for each of the stopping point candidates, a field of vision S of the surroundings recording sensor system 4 is predicted, taking into consideration the elevation profile of the roadway surface in the region of the crossroads SK, wherein the stopping point candidate at which the surroundings recording sensor system 4 has the greatest field of vision S is selected as the stopping position POS of the vehicle 1.

This stopping position POS is transmitted to the control unit 7 for controlling an automatic longitudinal and/or transverse movement of the vehicle 1, such that the vehicle 1 is guided to the stopping position POS and stops at this.

At the stopping position POS, a possible field of vision S of the surroundings recording sensor system 4 is ascertained depending on the map data KD by means of a further processing module 6.3, in particular using a roadway geometry off the crossroads SK included in it and using the fused data FD. In doing so, a further three-dimensional surroundings model UM2, in particular, is ascertained from the data D and/or the fused data FD, wherein using this, it is ascertained by means of the processing module 6.4 as to whether the field of vision S of the surroundings recording sensor system 4 can be enlarged at the stopping position POS by changing an orientation of the vehicle 1 by means of an active chassis 9 thereof. If this is the case, the orientation of the vehicle 1, i.e., an inclination thereof in relation to the roadway surface, is changed by means of the active chassis 9 in such a way that the field of vision S is maximized.

At the stopping position POS, it is additionally checked depending on the map data KD and the amalgamated data FD by means of the processing module 6.4 as to whether the field of vision S of the surroundings recording sensor system 4 can be further enlarged by means of further, in particular marginal, changes to the position of the vehicle 1 by means of an automatic longitudinal and/or transverse movement. If this is the case, the vehicle 1 is moved from the stopping position POS into a new stopping position POS by means of the control unit 7 for controlling the automatic longitudinal and/or transverse movement.

If the stopping position POS with the maximum field of vision S is reached and the inclination of the vehicle 1 by means of the active chassis 9 is correspondingly set, the vehicle surroundings at the stopping position POS are recorded by means of the surroundings recording sensor system 4. Depending on a traffic situation ascertained from the data D of the surroundings recording sensor system 4 and/or the amalgamated data FD, the control module 11 steers the vehicle 1 automatically into the crossroads SK. This can be carried out by slowly feeling its way in, for example.

Although the invention has been illustrated and described in detail by way of preferred embodiments, the invention is not limited by the examples disclosed, and other variations can be derived from these by the person skilled in the art without leaving the scope of the invention. It is therefore clear that there is a plurality of possible variations. It is also clear that embodiments stated by way of example are only really examples that are not to be seen as limiting the scope, application possibilities or configuration of the invention in any way. In fact, the preceding description and the description of the figures enable the person skilled in the art to implement the exemplary embodiments in concrete manner, wherein, with the knowledge of the disclosed inventive concept, the person skilled in the art is able to undertake various changes, for example, with regard to the functioning or arrangement of individual elements stated in an exemplary embodiment without leaving the scope of the invention, which is defined by the claims and their legal equivalents, such as further explanations in the description.

### LIST OF REFERENCE NUMERALS

1 Vehicle
2 Vehicle
3 Vehicle
4 Surroundings recording sensor system
5 Device
6 Processing unit
6.1 to 6.4 Processing module
7 Control unit
8 Digital road map
9 Active chassis
10 Amalgamation module
11 Control module
D Data
E Elevation
FB1 bis FB4 Carriageway
FD Amalgamated Data
KD Map data
L Pothole
POS Stopping position
S Field of vision
SK Crossroads
UM1 Surroundings model
UM2 Surroundings model

1-10. (canceled)

11. A method for controlling an automatically driving vehicle in a region of a crossroads using data recorded by a surroundings recording sensor system, the method comprising:
determining, before reaching the crossroads along a roadway lying ahead of the vehicle until the crossroads are reached, several future vehicle positions as stopping point candidates;
predicting, for each of the stopping point candidates and taking into consideration an elevation profile of a roadway surface in the region of the crossroads, a field of vision of the surroundings recording sensor system;
selecting, as a stopping position of the vehicle, a stopping point candidate of the stopping point candidates at which the surroundings recording sensor system has a greatest field of vision;
recording, by the surroundings recording sensor system at the stopping position, vehicle surroundings; and
automatically steering the vehicle into the crossroads depending on a traffic situation determined from the recorded vehicle surroundings.

12. The method of claim 11, wherein an orientation of the vehicle at the stopping position is changed by an active chassis of the vehicle in such a way that the field of vision of the surroundings recording sensor system is maximized.

13. The method of claim 11, wherein a position of the vehicle at the stopping position is changed by an automatic longitudinal or transverse movement of the vehicle in such a way that the field of vision of the surroundings recording sensor system is maximized.

14. The method of claim 11, wherein the stopping point candidates are determined using map data of a digital road map.

15. The method of claim 11, wherein the stopping point candidates are determined using model data of a surroundings model.

16. The method of claim 15, wherein the surroundings model is generated by the recorded vehicle surroundings.

17. The method of claim 15, wherein data of a three-dimensional further surroundings model of the vehicle surroundings is compiled using vehicle surroundings recorded at the stopping position by the surroundings recording sensor system.

18. The method of claim 17, wherein an orientation of the vehicle for maximizing the field of vision of the surroundings recording sensor system is determined using the three-dimensional further surroundings model and map data of a digital road map.

19. A device for controlling an automatically driving vehicle in a region of a crossroads with a surroundings recording sensor system, the device comprising:
a processing unit configured to
determine, before reaching the crossroads along a roadway lying ahead of the vehicle until the crossroads are reached, several future vehicle positions as stopping point candidates;
predict, for each of the stopping point candidates and taking into consideration an elevation profile of a roadway surface in the region of the crossroads, a field of vision of the surroundings recording sensor system; and
select, as a stopping position of the vehicle, a stopping point candidate of the stopping point candidates at which the surroundings recording sensor system has a greatest field of vision; and
a control unit configured to automatically steer the vehicle into the crossroads depending on a traffic situation determined from vehicle surroundings recorded by the surroundings recording sensor system.

20. The device of claim 19, further comprising:
an active chassis configured to change an orientation of the vehicle at the stopping position in such a way that the field of vision of the surroundings recording sensor system is maximized.
